(19) United States
(12) Patent Application Publication
(10) Pub. No.: US 2016/0306087 A1
(43) Pub. Date: Oct. 20, 2016

(54) DISPLAY APPARATUS

(71) Applicant: SAMSUNG ELECTRONICS CO., LTD., Suwon-si (KR)

(72) Inventors: Wook-Jae JEON, Hwaseong-si (KR); Eun IL CHO, Seoul (KR); Go Hyun KIM, Yongin-si (KR); Jun Sung CHOI, Yongin-si (KR)

(73) Assignee: SAMSUNG ELECTRONICS CO., LTD., Suwon-si (KR)

(21) Appl. No.: 15/133,707

(22) Filed: Apr. 20, 2016

(30) Foreign Application Priority Data
Apr. 20, 2015 (KR) 10-2015-0055262

(51) Int. Cl. G02B 5/30; F21V 8/00

(52) U.S. Cl. CPC G02B 5/3066; G02B 6/0068

(57) ABSTRACT

A display apparatus including a polarizing member attached to a rear surface of a transparent panel in front of a display panel. Accordingly, external light incident thereon is reflected by the polarizing member, thereby improving the aesthetic quality of the display apparatus.

### CROSS-REFERENCE TO RELATED APPLICATION

This application claims the priority from Korean Patent Application No. 10-2015-0055262, filed on Apr. 20, 2015, in the Korean Intellectual Property Office, the disclosure of which is incorporated herein by reference in its entirety.

### BACKGROUND

1. Field

Apparatuses consistent with exemplary embodiments relate to a curved display apparatus having a center portion that protrudes in a front direction or a rear direction.

2. Description of the Related Art

A display apparatus is an apparatus for displaying an image.

Generally, the display apparatus includes a display panel that provides a screen on which an image is displayed, a backlight that supplies light to the display panel, a substrate that delivers power and control signals to the display apparatus, and a chassis that supports the display panel and the backlight.

Recently, among these display apparatuses, there are display apparatuses that are formed to be curved so that a center portion protrudes in a front direction compared to both side portions.

In such display apparatuses, a display panel is formed to be curved so that a center portion protrudes in a front direction compared to both side portions, and a transparent panel is disposed to be separated in front of the display panel to protect the display panel.

### SUMMARY

Therefore, an aspect of exemplary embodiments may prevent degradation of exterior quality of a display apparatus that may occur when a plurality of reflected images are displayed because a transparent panel and a display panel both reflect lights when the transparent panel is disposed in front of the display panel.

Additional aspects of exemplary embodiments will be set forth in part in the description which follows and, in part, will be apparent from the description, or may be learned by practice.

According to an aspect of an exemplary embodiment, there is provided a display apparatus including a curved display panel, a curved transparent panel having curvature corresponding to curvature of the display panel and disposed in front of the display panel, and a polarizing member, disposed on a rear surface of the transparent panel, the polarizing member configured to transmit light polarized in one polarization direction and to reflect light polarized in other polarization directions.

The curvature of the display panel and the curvature of the transparent panel may be convex so that a center portion thereof protrudes in a front direction compared to side portions.

The curvature of the display panel and the curvature of the transparent panel are concave so that side portions thereof protrude in a front direction compared to a center portion.

An angle between an optical axis of light emitted from the display panel and an optical axis of the polarizing member may be substantially equal to 10 degrees or less than 10 degrees.

The polarizing member may be a film and attached to a rear surface of the transparent panel.

The display apparatus may further include at least one reinforcement member disposed on surface of the display panel.

The at least one reinforcement member may be formed in a rectangular ring shape and attached to the surface of the display panel.

The at least one reinforcement member may comprise a plurality of reinforcement members, formed in a rectangular bar shape, each of the plurality of reinforcement members attached to four sides of the surface of the display panel.

According to an aspect of an exemplary embodiment, there is provided a display apparatus including a display panel, a middle mold, a top chassis coupled to a front side of the middle mold to support an outer side of the display panel, a transparent panel disposed in front of the display panel, a case to support an outer side of the transparent panel, and a polarizing member disposed on a rear surface of the transparent panel to transmit light polarized in one polarization direction and to reflect polarized light in other polarization directions.

### BRIEF DESCRIPTION OF THE DRAWINGS

The above and other aspects of exemplary embodiments will become apparent and more readily appreciated from the following description, taken in conjunction with the accompanying drawings of which:

FIG. 1 is a perspective view of a display apparatus according to an exemplary embodiment;

FIG. 2 is an exploded perspective view showing an installation of a transparent display in a display apparatus according to an exemplary embodiment;

FIG. 3 is a perspective view of a display panel and a reinforcement member of a display apparatus according to an exemplary embodiment;

FIG. 4 is a cross-sectional view of a display apparatus according to an exemplary embodiment;

FIG. 5 is a perspective view of a display panel and a reinforcement member of a display apparatus according to an exemplary embodiment; and

FIG. 6 is a perspective view illustrating the paths of internal polarized light and external polarized light according to an exemplary embodiment.

### DETAILED DESCRIPTION OF EXEMPLARY EMBODIMENTS

Hereinafter, a display apparatus according to an exemplary embodiment of the present disclosure will be described with reference to the accompanying drawings.

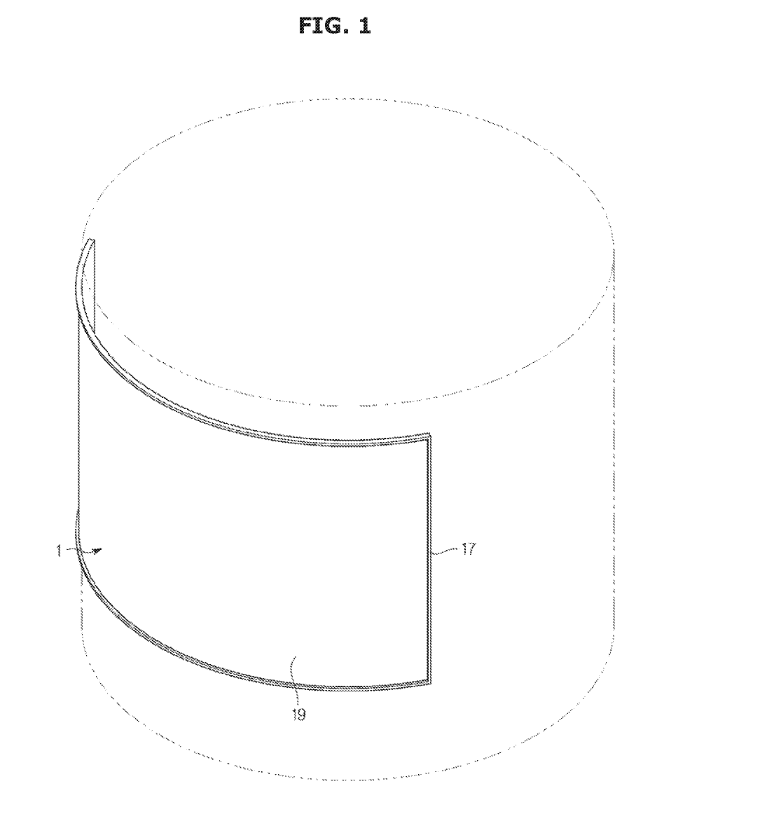

FIG. 1 is a perspective view of a display apparatus according to an exemplary embodiment.

As illustrated in FIG. 1, a display apparatus 1 according to an exemplary embodiment is formed to be curved so that a center portion thereof protrudes in a front direction compared to both side portions.

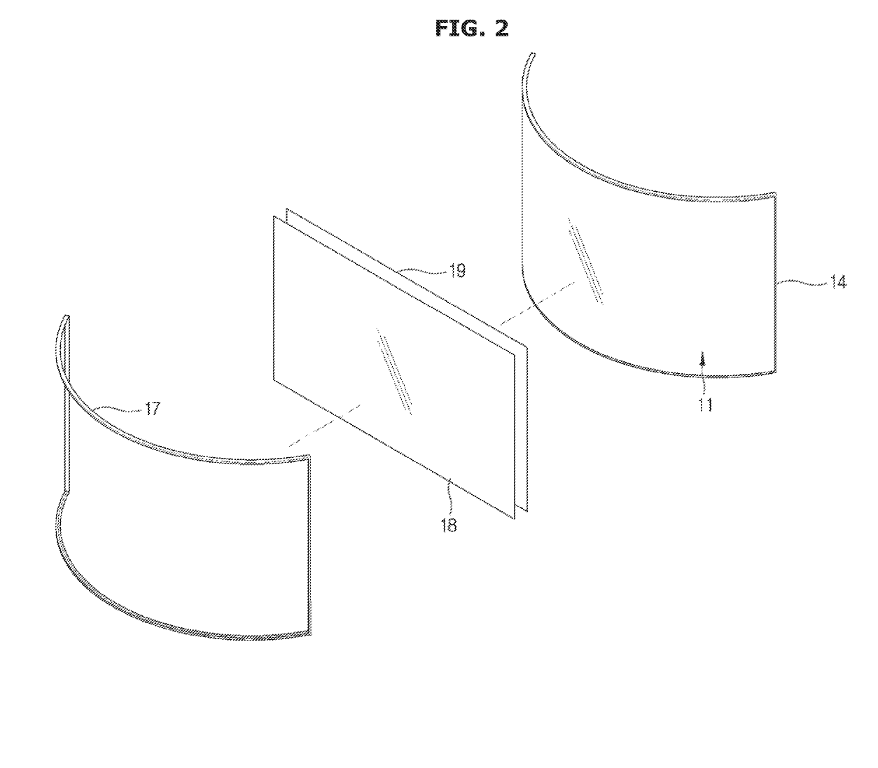

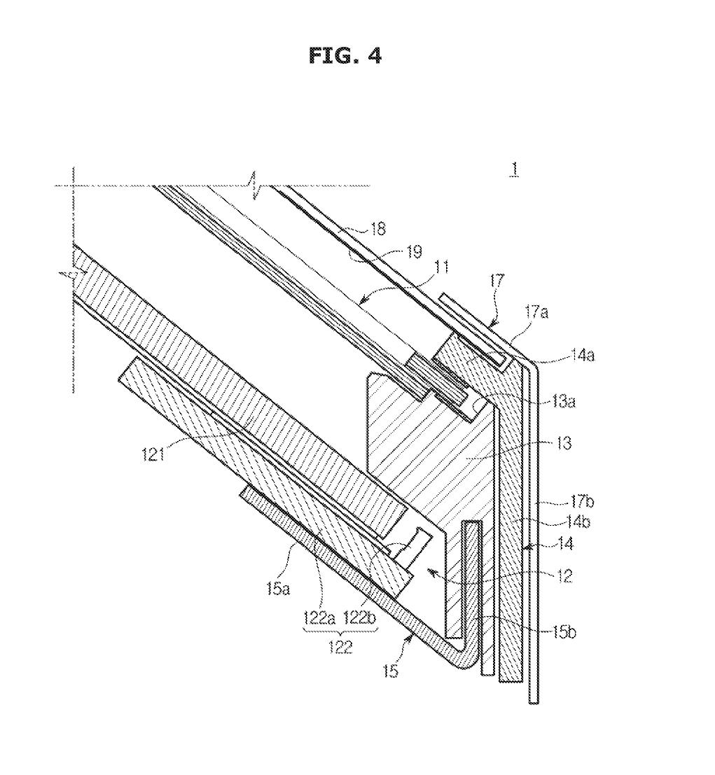

FIG. 2 is an exploded perspective view showing an installation of a transparent display in a display apparatus according to an exemplary embodiment. FIG. 4 is a cross-sectional view of a display apparatus according to an exemplary embodiment.

As illustrated in FIGS. 2 and 4, the display apparatus 1 includes a display panel 11, a backlight 12 that supplies light to the display panel 11, a middle mold 13 that supports the display panel 11 and the backlight 12, a top chassis 14 that enables the display panel 11 to be supported in front of the middle mold 13, and a bottom chassis 15 that enables the backlight 12 to be supported behind the middle mold 13.

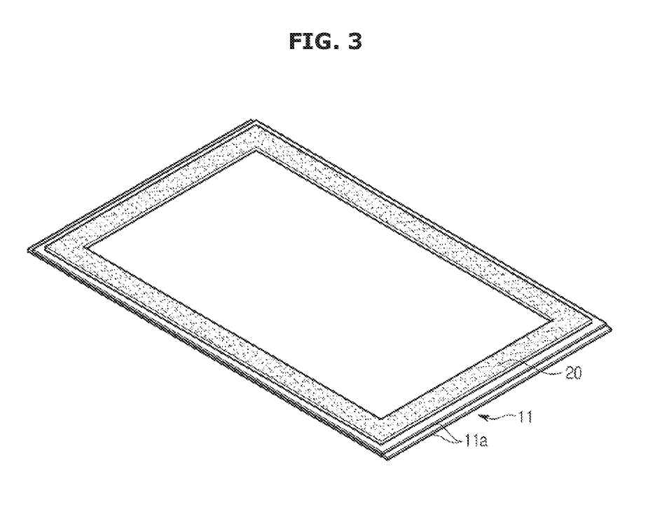

The display panel 11 is implemented with a liquid crystal panel in which liquid crystal is inserted to be sealed between two glass substrates 11a (see FIG. 3) each of which electrodes are provided.

The backlight 12 is formed in a rectangular plate shape and includes a light guide member 121 disposed behind the display panel 11, and four light sources 122 disposed facing each other in four side surfaces which are above, below, left and right of the light guide member 121.

In this embodiment, each of the four light sources 122 includes a substrate 122a that extends with a length corresponding to one of the four side surfaces of the light guide member 121, and a plurality of light emitting diodes 122b arranged in a line on the substrate 122a to face one of the four side surfaces of the light guide member 121. Therefore, light generated from the light emitting diodes 122b enters the light guide member 121 through the four side surfaces, which are above, below, left and right of the light guide member 121, and is guided to emit toward a front direction to the display panel 11 by the light guide member 121. In this embodiment, the four light sources 122 correspond to the four side surfaces of the light guide member 121 but are not limited thereto, and it is possible to use one or two light sources corresponding to one or two of the four side surfaces of the light guide member.

The middle mold 13 includes a panel accommodating portion 13a provided in front of the middle mold 13 so that the display panel 11 is placed and supported and a backlight accommodating portion 13a provided behind the middle mold 13 to accommodate the backlight 12.

The top chassis 14 includes a top front surface part 14a that supports the outer side of the display panel 11 and a top side part 14b coupled to the middle mold 13.

The bottom chassis 15 includes a rear part 15a formed in a rectangular plate shape to support the rear surface of the light guide member 121 and a bottom side part 15b coupled to the middle mold 13. The bottom chassis 15 is formed of a metal material, which has a high heat dissipation characteristic, such as aluminum or a stainless steel.

In addition, the display apparatus 1 includes a transparent panel 18 disposed in front of the display panel 11 to protect the display panel 11 and a case 17 that forms an exterior of the display apparatus 1 to support the outer side of the transparent panel 18.

The transparent panel 18 is formed in a rectangular plate shape to correspond to the display panel 11 and made of a transparent material having a high strength, such as tempered glass. Here, a rear surface of the transparent panel 18 is disposed to be separated from a front surface of the display panel 11 so that a shock is not delivered to the display panel 11 when the shock is applied to the transparent panel 18 from the outside.

The case 17 is formed in a rectangular ring shape to form a front outer side of the display apparatus 10. The case 17 includes a bezel part 17a that supports a front outer side of the transparent panel 18 so that the transparent panel 18 is supported by the middle mold 13 and a case side part 17b coupled to the top chassis 14

In this embodiment, the middle mold 13, the top chassis 14, the bottom chassis 15 and the case 17 are formed to be curved so that the center portions thereof protrude compared to both side portions, and each of the display panel 11 and the transparent panel 18 is formed in a plate shape. The display panel 11 is transformed to be curved in a process of coupling between the middle mold 13 and the top chassis 14 so that the center portions protrude compared to both side portions. As illustrated in FIG. 2, the transparent panel 18 is transformed to be curved in a process of coupling between the top chassis 14 and the case 17 so that the center portions protrude compared to both side portions.

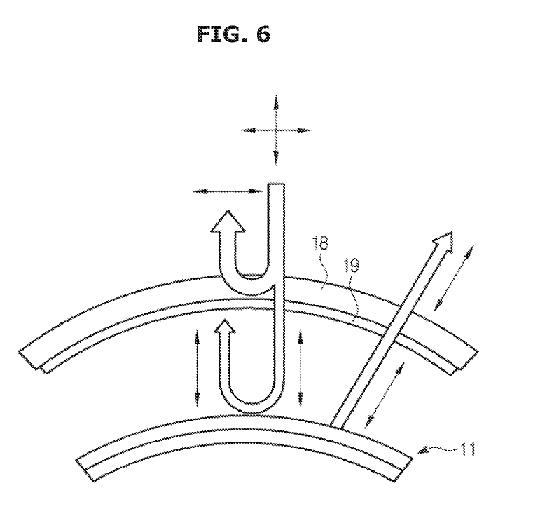

FIG. 6 is a perspective view illustrating the paths of internal polarized light and external polarized light according to an exemplary embodiment. As shown in FIG. 6, a polarizing member 19 that transmits polarized light in one polarization direction and reflects polarized light in the remaining polarization directions is disposed on the rear surface of the transparent panel 18. In this embodiment, the polarizing member 19 is manufactured in the form of a film and attached to the rear of the transparent panel 18.

In this embodiment, it is preferable that a polarization axis of the polarizing member 19 is the same as an axis of optical light emitted from the display panel 11. However, because it is difficult to implement the above feature in an actual implementation, the angle between the polarization axis of the polarizing member 19 and the optical axis of the light emitted from the display panel 11 is preferably 10 degrees or less. In such a configuration, some loss of light occurs, but, according to Malus' law, the light emitted from the display panel 11 can be emitted in the front direction of the display apparatus 1 through the polarizing member 19.

When the display panel 11 and the polarizing member 19 is configured as described above, most of the external light incident on the transparent panel 18 is reflected in the front direction by the polarizing member 19, and thus, the transparent panel 18 serves as a mirror when the display apparatus 1 is not operated.

Further, when the display apparatus 1 is operated, because most of light emitted from the display panel 11 is transmitted through the polarizing member 19 and the transparent panel 18 in the front direction, a user in the front can see the light emitted from the display panel 11.

Further, in the display apparatus as described above, it is preferable that the display panel 11 and the transparent panel 18 are formed to be curved to have the same center of curvature and thus the display panel 11 and the transparent panel 18 could have a constant distance therebetween.

However, according to the characteristics of glass, it is almost impossible to have a constant distance between the display panel 11 and the transparent panel 18. That is, there are many cases in which the distance between the center portion of the display panel 11 and the center portion of the transparent panel 18 and the distance between both side portions of the display panel 11 and both side portions of the transparent panel 18 are inevitably vary.

In the situation described above, since a portion of the light in the front direction of the display apparatus 1 incident on the transparent panel 18 is reflected by the front surface of the transparent panel 18 and the glass substrate 11a which forms the front surface of the display panel 11, two reflected images are seen in the form of overlapping images. Also, as described above, because the distance between the display panel 11 and the transparent panel 18 vary depending on left and right positions, the distance between the two reflected images vary depending on left and right positions, and thus the images become obfuscated.

However, as described above, when the polarizing member 19 is disposed on the rear surface of the transparent panel 18, as illustrated in FIG. 6, most of the light incident on the transparent panel 18 from the front side is reflected by the polarizing member 19, and only a very small portion of the light is transmitted through the polarizing member 19 to the display panel 11 and is reflected by the front surface of the display panel 11.

Here, because the quantity of the light reflected by the front surface of the display panel 11 is very small compared to that of the light reflected by the polarizing member 19, the user may recognize only the light reflected by the polarizing member 19.

Therefore, when the display apparatus 1 is not used, the exterior of the display apparatus 1 is visually aesthetic because of the polarizing member 19.

Also, the glass substrate 11a that constitutes the display panel 11 should be formed to be thinner than the glass substrate of the display panel that is used to be in a plate shape so that the display panel 11 could be successfully curved. In this manner, when the thin glass substrate is used, the strength of the display panel 11 is lowered correspondingly to the decrease in thickness.

FIG. 3 is a perspective view of a display panel and a reinforcement member of a display apparatus according to an exemplary embodiment. As illustrated in FIG. 3, a reinforcement member 20 that reinforces the strength of the display panel 11 is attached to the display panel 11. In this embodiment, the reinforcement member 20 is formed in a rectangular ring shape to correspond to four sides of the display panel 11 and attached to one of two surfaces of the display panel 11.

Therefore, the display panel 11 can easily be transformed to be curved, and the strength of the display panel 11 can be increased by the reinforcement member 20.

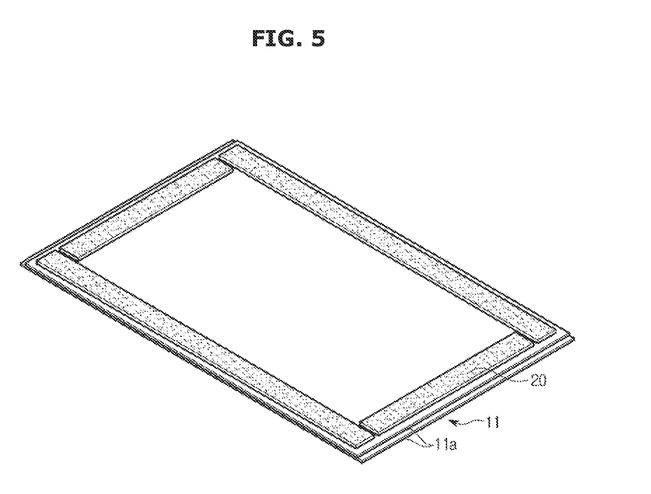

Further, FIG. 5 is a perspective view of a display panel and a reinforcement member of a display apparatus according to an exemplary embodiment. As illustrated in FIG. 5, it is possible that four reinforcement members formed in a rectangular bar shape are attached to four outer sides of one surface of the display panel 11.

In this embodiment, the display apparatus 1 is transformed to be curved so that the center portion thereof protrudes in the front direction compared to both side portions but not limited thereto. For example, both side portions of the display apparatus may protrude in the front direction compared to the center portion, and it is still applicable. Further, the upper and lower portions of the display apparatus may protrude in the front direction or rear direction compared to the center portion, and it is still applicable.

In the display apparatus according to an embodiment, the polarizing member 19 is disposed on the rear surface of the transparent panel 18 to reflect light polarized in the remaining polarization directions except for one polarization direction, thereby preventing degradation of the exterior quality of the display due to the occurrence of a plurality of reflected images.

The embodiments disclosed in this specification and drawings are only examples to help understanding of the invention and the invention is not limited thereto. It is apparent to those skilled in the art that various modifications based on the technological scope of the invention in addition to the embodiments disclosed herein can be made. Therefore, it is understood that the invention covers various equivalents, modifications, and substitutions at the time of filing of this application.

What is claimed is:

1. A display apparatus comprising:
a curved display panel;
a curved transparent panel having curvature corresponding to curvature of the display panel and disposed in front of the display panel; and
a polarizing member, disposed on a rear surface of the transparent panel, the polarizing member configured to transmit light polarized in one polarization direction and to reflect light polarized in other polarization directions.

2. The display apparatus of claim 1, wherein the curvature of the display panel and the curvature of the transparent panel are convex so that a center portion thereof protrudes in a front direction compared to side portions.

3. The display apparatus of claim 1, wherein the curvature of the display panel and the curvature of the transparent panel are concave so that side portions thereof protrude in a front direction compared to a center portion.

4. The display apparatus of claim 1, wherein an angle between an optical axis of light emitted from the display panel and an optical axis of the polarizing member is substantially equal to 10 degrees or less than 10 degrees.

5. The display apparatus of claim 1, wherein the polarizing member is a film and attached to a rear surface of the transparent panel.

6. The display apparatus of claim 1, further comprising:
at least one reinforcement member disposed on one surface of the display panel.

7. The display apparatus of claim 6, wherein the at least one reinforcement member is formed in a rectangular ring shape and attached to the surface of the display panel.

8. The display apparatus of claim 6, wherein the at least one reinforcement member comprises a plurality of reinforcement members, formed in a rectangular bar shape, each of the plurality of reinforcement members attached to four sides of the surface of the display panel.

9. A display apparatus comprising:
a display panel;
a middle mold configured to support the display panel;
a top chassis coupled to a front side of the middle mold;
a transparent panel disposed in front of the display panel;
a case configured to support an outer side of the transparent panel; and
a polarizing member, disposed on a rear surface of the transparent panel, the polarizing member configured to transmit light polarized in one polarization direction and to reflect polarized light in other polarization directions.

10. The display apparatus of claim 9, wherein curvature of the display panel and curvature of the transparent panel are convex so that a center portion thereof protrudes in a front direction.

11. A display apparatus comprising:
a curved display panel;
a curved transparent panel have a curvature corresponding to a curvature of the display panel and disposed in front of the display panel; and
a polarizing member, disposed on a rear surface of the transparent panel, the polarizing member configured to transmit light emitted from the display panel and to reflect external light incident through the transparent panel on the polarizing member.

12. The display apparatus of claim 11, further comprising:
a middle mold configured to support the display panel; and
a top chassis coupled to a front side of the middle mold and configured to support an outer side of the display panel.

13. The display apparatus of claim 12, wherein the display panel is curved based on coupling between the middle mold and the top chassis.

14. The display apparatus of claim 12, further comprising:
a case configured to support an outer side of the transparent panel.

15. The display apparatus of claim 14, wherein the transparent panel is curved based on coupling between the top chassis and the case.

16. The display apparatus of claim 11, wherein the polarizing member is a film and attached to a rear surface of the transparent panel.
